(19) United States
(12) Patent Application Publication
(10) Pub. No.: US 2014/0345417 A1
(43) Pub. Date: Nov. 27, 2014

(54) Shaft Assembly

(71) Applicants: Gregor Heitzler, Freiburg (DE); Markus Schuler, Oberwolfach (DE)

(72) Inventors: Gregor Heitzler, Freiburg (DE); Markus Schuler, Oberwolfach (DE)

(73) Assignee: Amtek Tekfor Holding GmbH, Hausach (DE)

(21) Appl. No.: 14/239,081

(22) PCT Filed: Aug. 13, 2012
(86) PCT No.: PCT/DE2012/000812

§ 371 Date: Aug. 15, 2014

(30) Foreign Application Priority Data
Sep. 17, 2011 (DE) 10 2011 110 871.1

(51) Int. Cl. F16C 3/02; F16C 19/46

(52) U.S. Cl. CPC F16C 3/02; F16C 19/46
USPC 74/567

(57) ABSTRACT

A shaft assembly with a roller bearing arrangement is provided. The shaft has a tooth system with a specifiable number of depressions and elevations. The roller bearing is a bearing with a specifiable number of roller bodies. The roller bearing may be a needle bearing with roller bodies in the form of bearing needles. The number of depressions may be equal to, or greater than, the number of roller bodies.

This application is a National Phase of PCT International Application No. PCT/DE2012/000812, filed Aug. 13, 2012, which claims priority under 35 U.S.C. §119 from German Patent Application No. 10 2011 110 871.1, filed Sep. 17, 2011, the entire disclosures of which are expressly incorporated by reference herein.

### BACKGROUND AND SUMMARY OF THE INVENTION

Fabricated camshafts with needle bearings mounted on the shaft are disclosed in the prior art (German Utility Patent No. DE 20 2006 018 359 U1). Needle bearings with split bearing shells for camshafts are also disclosed (German Utility Patent No. DE 20 2008 010 554 U1). German Utility Patent No. DE 10 2006 057 695 A1, for example, shows an axial fixing of a roller bearing.

The invention is based on the object of enabling a roller bearing to be easily fitted to a shaft, such as the shaft of a camshaft for example.

The invention achieves the object by a shaft assembly having at least one shaft and having at least one roller bearing, wherein, in at least some sections, the shaft has a tooth system with a specifiable number of depressions and elevations, wherein the roller bearing is a bearing with a specifiable number of roller bodies, and wherein the number of depressions is at least equal to the number of roller bodies. In an embodiment, the bearing has, in particular, an undivided cage or an undivided bearing outer ring.

An embodiment includes that the depressions of the tooth system and the roller bodies in the roller bearing are compatibly formed with respect to one another and matched to one another. Preferably, the depth of the depressions and the distance by which the roller bodies, e.g. needles, project from the cage of the bearing are matched to one another so that the roller bodies/needles fit into the depressions. Furthermore, the radial distributions of depressions and roller bodies in the tooth system and in the roller bearing respectively are preferably matched to one another. The shaft section which forms the bearing point of the roller bearing and therefore constitutes the bearing inner ring therefore has a diameter which is greater than the root circle and less than the tip circle of the tooth system.

An embodiment provides that the number of depressions is equal to an integer multiple of the number of roller bodies. In this embodiment, there are therefore more depressions than roller bodies. Alternatively, the number of depressions is equal to the number of roller bodies.

An embodiment includes that the shaft has at least one end, that the shaft has a position section for the roller bearing, and that the tooth system of the shaft extends at least from the end of the shaft to an end of the position section which faces away from the end of the shaft. In this embodiment, the tooth system extends at least far enough to enable the roller bearing to be fitted from an end of the shaft as far as the positioning section on which the roller bearing remains.

An embodiment consists in that the roller bearing is a needle bearing and the roller bodies are needles.

An embodiment provides that the shaft assembly is camshaft, in particular a fabricated camshaft. In this embodiment, at least cams are also provided on the shaft.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1: shows a spatial representation of part of a camshaft according to an embodiment of the invention, and

FIG. 2: shows a section at the level of a needle bearing positioned on the camshaft of the FIG. 1 embodiment

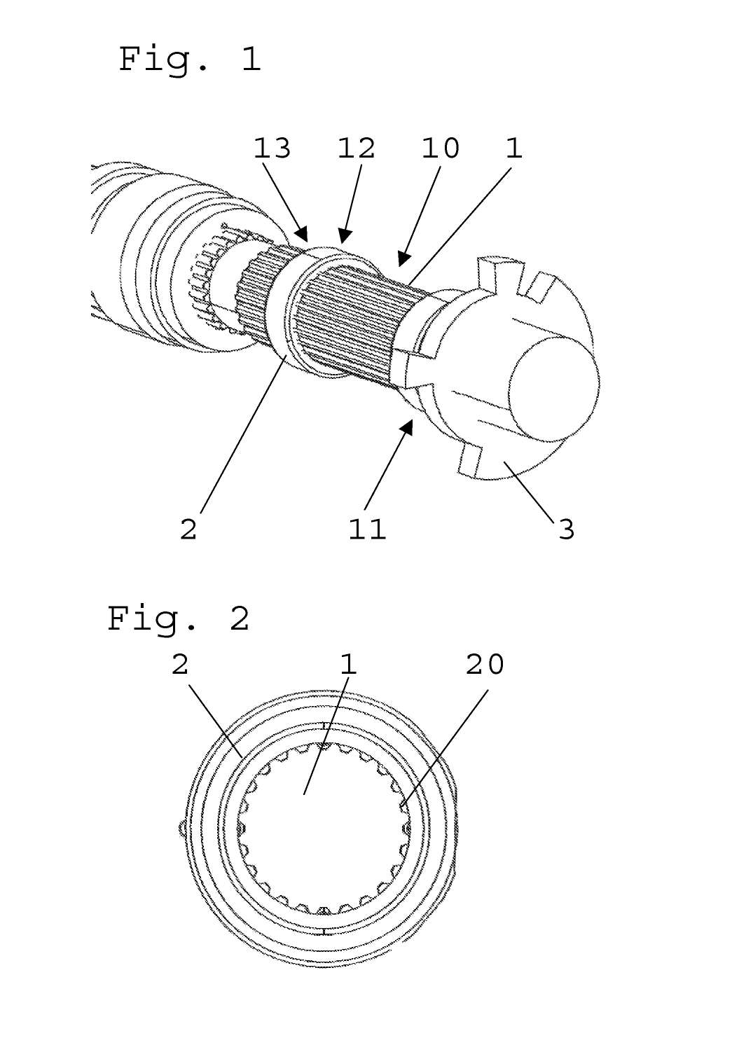

FIG. 1 shows a camshaft as an example of a shaft assembly.

### DETAILED DESCRIPTION OF THE DRAWINGS

At an end 11 of the shaft 1 is a sensor wheel 3. The shaft 1 has a tooth system 10 with depressions (valleys) and elevations (peaks). On the position section 12 is a roller bearing 2. The tooth system 10 extends at least from the one end 11 of the shaft 1 to the end 13 of the position section 12 which faces away from the end 11 of the shaft 1, and, in the variant shown, extends beyond said end.

The roller bearing 2 is shown in the section of FIG. 2. It can be seen how the needles 20 as roller bodies extend inwards from the cage of the roller bearing 2. Only four rollers are shown here by way of example.

According to the invention, the depressions of the tooth system 10 of the shaft 1 and the roller bearing 2 and the needles 20 respectively are matched to one another in such a way that the needles 20 fit into the depressions of the tooth system 10, and that the number of depressions is at least equal to the number of needles 20 or equal to an integer multiple of the number of needles 20. Therefore, the number of depressions=the number of needles*n, where n is an integer greater than or equal to 1. Matching the tooth system to the roller bearing in particular also enables standard roller bearings to be used. Furthermore, as a result of the matching, bearing inner rings and assembly rings on the shaft can be dispensed with, as, according to the invention, the shaft constitutes the bearing inner ring. A further advantage is that a possible stepping of the shaft can be omitted.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. A shaft assembly, comprising:
at least one shaft, and
at least one roller bearing,
wherein, in at least one section, the shaft has a tooth system with a predetermined number of depressions and elevations,
wherein the roller bearing is a bearing with a predetermined number of roller bodies, and
wherein the number of depressions is equal to or greater than the number of roller bodies.

2. The shaft assembly as claimed in claim 1, wherein
the depressions of the tooth system and the roller bodies in the roller bearing are compatibly formed with respect to one another such that at least a portion of each roller body is locatable in a corresponding one of the depressions.

3. The shaft assembly as claimed in claim 1, wherein
the predetermined number of depressions is equal to an integer multiple of the predetermined number of roller bodies.

4. The shaft assembly as claimed in claim 1, wherein,
the shaft has at least one end,
the at least one section of the shaft is a position section for the roller bearing, and
the tooth system of the shaft extends at least from the end of the shaft to an end of the position section opposite the end of the shaft.

5. The shaft assembly as claimed in claim 1, wherein
the roller bearing is a needle bearing and the roller bodies are needles.

6. The shaft assembly as claimed in claim 1, wherein
the shaft assembly is a camshaft.
